(19) United States
(12) Patent Application Publication
(10) Pub. No.: US 2024/0157226 A1
(43) Pub. Date: May 16, 2024

(54) SHAPE MEMORY POLYMER-BASED GAME KIT

(71) Applicant: Nano and Advanced Materials Institute Limited, Hong Kong (HK)

(72) Inventors: Yong ZHU, Hong Kong (HK); Pao Chieh WANG, Hong Kong (HK); Yangfan ZHOU, Hong Kong (HK); Jenny Wai Hang YIU, Hong Kong (HK)

(21) Appl. No.: 18/423,316

(22) Filed: Jan. 26, 2024

Related U.S. Application Data
(63) Continuation-in-part of application No. 16/404,701, filed on May 6, 2019.
Application No. 16/404,701 is a continuation-in-part of application No. 17/344,929, filed on Jun. 10, 2021, now Pat. No. 11,926,932.
(60) Provisional application No. 62/762,815, filed on May 22, 2018.
(60) Provisional application No. 62/702,337, filed on Jul. 23, 2018.
(60) Provisional application No. 63/102,630, filed on Jun. 24, 2020.

(51) Int. Cl. A63F 9/00; A63F 1/04; A63F 11/00; C08L 75/04

(52) U.S. Cl. CPC A63F 9/001; A63F 1/04; A63F 11/0074; C08L 75/04; A63F 2001/0441; A63F 2011/0086; A63F 2250/1026; A63F 2250/18; C08L 2203/12; C08L 2203/30; C08L 2205/025

(57) ABSTRACT

The invention relates to a shape memory polymer-based game kit. The kit includes a plurality of elastic copolymer materials and an an instruction manual comprising one or more user instructions specifying rules of one or more games. Each of the elastic copolymer materials being mechanically manipulate able from its original shape into one or more three-dimensional structures, and reverse back to its original shape by being subjected to a stimulus having a shape recovery temperature. These materials offer a secure and non-toxic alternative for children's toys and item decoration.

### CROSS-REFERENCE TO RELATED APPLICATIONS

The present application is a continuation-in-part of U.S. patent application Ser. No. 17/344,929 filed Jun. 10, 2021; which claims priority to U.S. Provisional Patent Application No. 63/102,630 filed Jun. 24, 2020; the disclosures of which are incorporated by reference herein in their entirety. The present application is also a continuation-in-part of U.S. patent application Ser. No. 16/404,701 filed May 6, 2019; which claims priorities to U.S. Provisional Patent Application No. 62/702,337 filed Jul. 23, 2018 and U.S. Provisional Patent Application No. 62/762,815 filed May 22, 2018; the disclosures of which are incorporated by reference herein in their entirety.

### FIELD OF THE INVENTION

The present invention generally relates to the field of elastic materials, thermodynamics, versatile game kit design, and manufacturing processes, etc.

### BACKGROUND OF THE INVENTION

Over the past years, there has been a growing emphasis on safety of children's toys. This heightened focus arises from the increasingly strict regulatory mandates to guarantee that these products do not pose any risks to the health of children during usage. Traditional children's toys commonly employ materials like plastic and rubber. However, under specific circumstances, these materials may incorporate plasticizers or other toxic substances, thereby introducing potential safety hazards. The utilization of innovative materials, such as shape memory polymers (SMP), becomes integral in this pursuit, providing a foundation for non-toxic, safe, and yet engaging children's toys.

SMPs are materials that have a first, “permanent” configuration and a second “temporary” configuration that results from deformation of the material. Upon receiving an external stimulus, such as heat, solvent, electrical current, light, magnetic field, change of pH, and thermal stimulus, the material returns to its permanent configuration. That is, the material “remembers” its original shape and returns to that shape after undergoing the external stimulus.

Shape memory filaments and fibers can be made by melt-spun, wet-spun and dry-spun methods. In such smart fibers, the shape memory function can be preserved, i.e., deformation can be memorized by a reversible phase and the original shape can be recovered when triggered by an external stimulus. Bi-component filaments and fibers have been widely developed as a new type of man-made fibre since the 1960s. Through such technology, two different polymers with suitable viscosity, composition are co-extruded together into one filament through a spinneret from two separate extenders. The cross section of the filament can be different patterns, including concentric sheath/core, eccentric sheath/core, side-by-side, pie wedge, islands/sea mode, which depends on an application requirement.

However, all the long fibers and filaments in the above-mentioned patent applications are limited to two components, and they are difficult to freely transform between linear or coiled/spiral shapes. Given the drawbacks of existing SMPs, there is a need to provide a shape memory material that is non-toxic and adjustable in coiled shapes under different conditions, offering children a safer and healthier gaming experience.

### SUMMARY OF THE INVENTION

Accordingly, a first aspect of the present invention provides a shape memory polymer-based game kit. The game kit includes a plurality of elastic copolymer materials, and an instruction manual comprising one or more user instructions specifying rules of one or more games. The instruction manual can be electronic or physical. Each of the elastic copolymer materials being mechanically manipulatable from its original shape into one or more three-dimensional structures, and reverse back to its original shape by being subjected to a stimulus. The three-dimensional structures include one or more of curls, spirals, ringlets, waves, or coils.

In an embodiment, the stimulus is thermal energy radiated by a medium such as air, water or other fluid having a temperature at or above the shape recovery temperature.

In an embodiment, the plurality of elastic copolymer materials include multi-component shape memory threads, fibers, tubes, or tapes.

In an embodiment, the plurality of elastic copolymer materials includes at least two shape-memory polymeric (SMP-N) components, each of the at least two SMP-N components is of at least 1% of the total weight, and N is a positive integer starting from 1.

The SMP-N components have a selectively engineered shape recovery temperature (T r) between approximately −50° C. to 100° C., and the recovery temperature of two or more different components can be represented by T_{rN} and T_{rN+1} respectively.

When T_{rN} and T_{rN+1} are higher than room temperature and wherein T_{rN+1} is greater than Tr_{N}, the plurality of elastic copolymer materials is configured to assume a first shape change from an original shape to a straight, elongated shape in response to an elongation of the plurality of elastic copolymer materials to approximately 30% to approximately 300% of an original length and are configured to assume a second shape change to a substantially helical shape upon heating to a temperature above the T r N and lower than the T_{rN+1} and to assume a third shape change substantially back to the original shape upon heating to a temperature above T_{rN+1}.

In an embodiment, the one or more three dimensional structures of the plurality of elastic copolymer materials change by adjusting an elongation length or a stretching time of the plurality of elastic copolymer materials.

In an embodiment, the one or more of curls, spirals, ringlets, waves, or coils have a coil diameter from 0.5 to 10 mm and a number of the turns per cm from 5 to 30.

In an embodiment, the elongation length is in a range of 0.5 cm-50 cm.

In an embodiment, the stretching time is in a range of 0.1 s-60 s.

In another embodiment, the kit further includes one or more challenge cards; wherein each of the challenge cards comprises at least a task prompting a user to manipulate the plurality of elastic copolymer materials into a specified structure.

In another embodiment, the kit further includes a container to hold the thermal fluid, and a thermometer for measuring the thermo fluid temperature that helps protecting the user and allow the user to adjust the temperature of the thermo fluid.

In another embodiment, the kit further includes one or more building blocks with various shapes, each of the building blocks is configured to be attachable to another one of the building blocks via a connector; wherein each of one or more of the elastic copolymer materials is coupled to a connector for attaching to one of the building blocks. One or more building plates can also be included, and each of one or more of the elastic copolymer materials is coupled to a connector for attaching to one of the building plates.

In an embodiment, the one or more user instructions are printed on cards, papers, or a link provided to an interactive online, or downloadable video guide for games, or a combination thereof. For instance, the one or more user instructions can be delivered through a QR-code.

In another aspect, the present invention provides a shape memory polymer-based artwork tool kit, which includes said plurality of elastic copolymer filaments and one or more artwork tools. In particular, the shape memory polymer-based game kit is utilized for decorations, artworks, clothing, household items, or product surface designs, or other creative projects.

In another embodiment, the at least one of the elastic copolymer filaments having a color different from another one of elastic copolymer filaments.

In an embodiment, the artwork tools may include one or more brushes, rollers, molds, presses, blades, cutters, printers, or tubes.

The present invention has the following advantages: (1) Users can explore limitless design options by adjusting the elongation length or the stretching time of the elastic copolymer materials, allowing for a dynamic and customizable experience. (2) The shape recovery of the elastic copolymer materials is triggered at a safe and optimized temperature of approximately 38° C., ensuring a user-friendly and secure interaction with the material. (3) The elastic copolymer materials exhibit excellent elasticity, with the ability to withstand over 300% elongation, providing a wide range of shape transformations and creative possibilities. (4) The reversible helical-to-straight shape memory effect can be repeated for more than 500 cycles, demonstrating the material's robustness and long-lasting performance. (5) The game kit adheres to stringent toy material safety standards, including ROHS, REACH, EN71, EU2015/2030 (SCCPs), CPSIA, and more, ensuring the product meets regulatory requirements and is safe for use.

### BRIEF DESCRIPTION OF THE DRAWINGS

Embodiments of the present invention are described in more detail hereinafter with reference to the drawings, in which:

FIG. 1 illustrates a schematic diagram of the shape memory polymer-based game kit of the present invention;

FIG. 2 illustrates different embodiments of the present invention in terms of different arrangement of the shape-memory polymer (SMP) from the cross-sectional view in order to result in different three-dimensional structures;

FIG. 3 illustrates an elastic copolymer filament with controllable helical-to-straight shape memory effect;

FIG. 4 illustrates procedures of achieving multi-shape change function of a multi-component shape memory filament;

FIGS. 5A-5G show individually depict the mission cards and their corresponding task contents in the game kit of the present invention;

FIGS. 6A-6B illustrate a practical application of the shape memory polymer-based filaments in toys according to the present invention.

### DETAILED DESCRIPTION

The present invention will be described in detail through the following embodiments with appending drawings. It should be understood that the specific embodiments are provided for an illustrative purpose only, and should not be interpreted in a limiting manner. Those skilled in the art will appreciate that the invention described herein is susceptible to variations and modifications other than those specifically described.

The invention includes all such variation and modifications. The invention also includes all of the steps and features referred to or indicated in the specification, individually or collectively, and any and all combinations or any two or more of the steps or features. Other aspects and advantages of the invention will be apparent to those skilled in the art from a review of the ensuing description.

The present invention provides a game kit that incorporates a novel shape memory material, bringing a unique and engaging twist to the world of recreational activities.

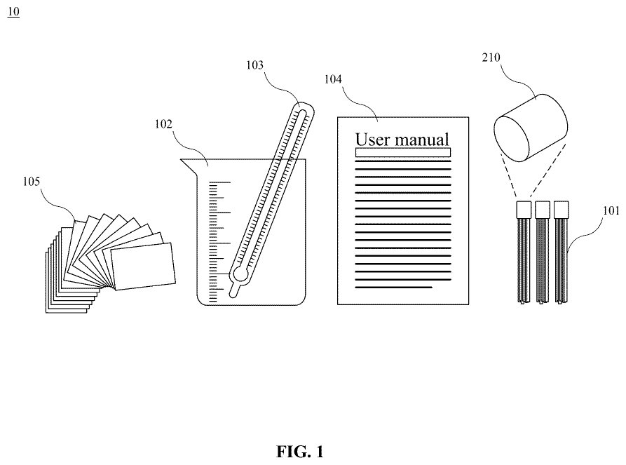

Referring to FIG. 1, the game kit 10 is designed to provide an interactive and dynamic experience for users of all ages. At its core, the kit features elastic copolymer materials 101, each of which can optionally be assembled with a connector 210, showcasing transformability from a straight shape to a structured shape such as a helical through mechanical manipulation such as stretching. What sets this invention apart is the utilization of a state-of-the-art shape memory material, allowing the elastic copolymer materials to seamlessly return to their original straight shape when exposed to a stimulus such as thermal energy having a specific temperature range (e.g., 38-40° C.), further enhancing the interactive play possibilities.

Accompanying the elastic copolymer materials 101 are components such as a container 102 designed to hold water, which is one of the media that carries and radiates the thermal energy stimulus. To ensure precise control, a thermometer 103 is included, allowing users to fine-tune the water temperature for optimal shape-manipulating of the elastic copolymer materials. The kit 10 is complemented by an instruction manual 104, which can be in electronic and/or physical form, for guiding users through the various functionalities of the kit 10 and shape manipulations of the elastic copolymer materials 101.

After being manipulated into a structured shape, subjecting the the elastic copolymer material 101 to a thermal energy stimulus having a temperature at or above the shape memory recover temperature returns the formed three-dimensional structure of an elastic copolymer material 101 to its approximately original shape. The medium that carries thermal energy stimulus may be air, water, a gel, or any other fluid that can envelope the three-dimensional structure. In various embodiments, a user may either immerse the shaped elastic copolymer material 101 into a container filled with water at approximately 40° C. or use a hairdryer. Both ways will allow the elastic copolymer material 10 to return to its original straight shape.

Adding an extra layer of excitement, the game kit 10 also includes one or more challenge cards 105. Each of the challenge cards 105 presents specific task information, encouraging users to explore the full potential of the shape memory material in a playful and engaging manner.

In one embodiment, the plurality of elastic copolymer materials 101 includes at least two shape-memory polymeric (SMP-N) components, each of the at least two SMP-N components is of at least 1% of the total weight, and N is a positive integer starting from 1. For instance, N can be 1, 2, 3, 4, 5, etc. The SMP-N components have a selectively engineered shape recovery temperature (Tᵣ) between approximately −50° C. to 100° C., and the recovery temperature of two or more different components can be represented by T_{rN} and T_{rN+1} respectively.

In accordance with one embodiment, the cross-sections of the at least two SMP-N components are in side-by-side, eccentric sheath/core, circumferential, or layer-by-layer structure.

In accordance with one embodiment, the plurality of elastic copolymer materials comprise multi-component shape memory threads, fibers, tubes, or tapes. Each of the at least two shape-memory polymeric components may be polyester-based polyurethane shape memory material, a polyether-based polyurethane shape memory material, and other suitable shape-memory polymeric materials. Preferably, the polyester-based polyurethane shape memory material is a polycaprolactone-based shape memory material.

In one embodiment, the SMPs are expected to include, but not limit to, Diaplex 2520, 3520, 4520. However, the materials of SMPs are not limited to thermal-sensitive shape memory polymers, but includes other polymers that are sensitive to other stimuli, such as moisture/water-sensitive shape memory polymers, photosensitive shape memory polymers, and radiation-sensitive shape memory polymers.

In accordance with one embodiment, the threads or fibers have a diameter in a range of approximately 0.1 to 2 mm.

In accordance with one embodiment, the tubes or tapes have a thickness in a range of approximately 0.5 to 1 mm.

When T_{rN} and T_{rN+1} are higher than room temperature and wherein T_{rN+1} is greater than Tr_{N}, the plurality of elastic copolymer materials is configured to assume a first shape change from an original shape to a straight, elongated shape in response to an elongation of the plurality of elastic copolymer materials to approximately 30% to approximately 300% of an original length and are configured to assume a second shape change to a substantially helical shape upon heating to a temperature above the T_{rN} and lower than the T_{rN+1} and to assume a third shape change substantially back to the original shape upon heating to a temperature above T_{rN+1}.

When T_{rN} is lower than room temperature and T_{rN+1} are higher than room temperature and wherein T_{rN+1} is greater than Tr_{N}, the plurality of elastic copolymer materials is configured to assume the shape change from a first straight shape to a second helical shape in response to an elongation of the plurality of elastic copolymer materials to approximately 30% to approximately 300% of an original length. The shape change from helical shape back to the original straight shape upon heating to a temperature above the T_{rN+1}.

In accordance with one embodiment, when the at least two SMP-N components are SMP-1 and SMP-2, the SMP-1 and SMP-2 are co-extruded at a weight ratio of 1-10:10-1. The Tᵣ (Tᵣ₁) of SMP-1 is lower than that of the SMP-2(Tᵣ₂), and the Tᵣ is either the melting point or glass transition temperature of the SMP-1 and the SMP-2. The Tᵣ₁ of the SMP-1 is approximately −30° C., and Tᵣ₂ of the SMP-2 is approximately 35° C.

In accordance with one embodiment, the helical shape has a coil diameter from 0.5 to 10 mm and a number of the turns per cm from 5 to 30.

In another aspect, the present invention also provides a method for producing the elastic copolymer materials, the method includes co-extruding multi-components together to form the elastic copolymer materials. The multi-components contain at least two shape-memory polymeric (SMP-N) components, and each of the at least two SMP-N components is of at least 1% of the total weight, and a weight ratio between the at least two SMP-N components is 1:10. N is a positive integer starting from 1, including components SMP-1, SMP-2, SMP-3, SMP-4, etc. In the present invention, the quantity of SMP components is no less than two. In particular, at least two SMP-N components can be potentially used in the elastic copolymer materials.

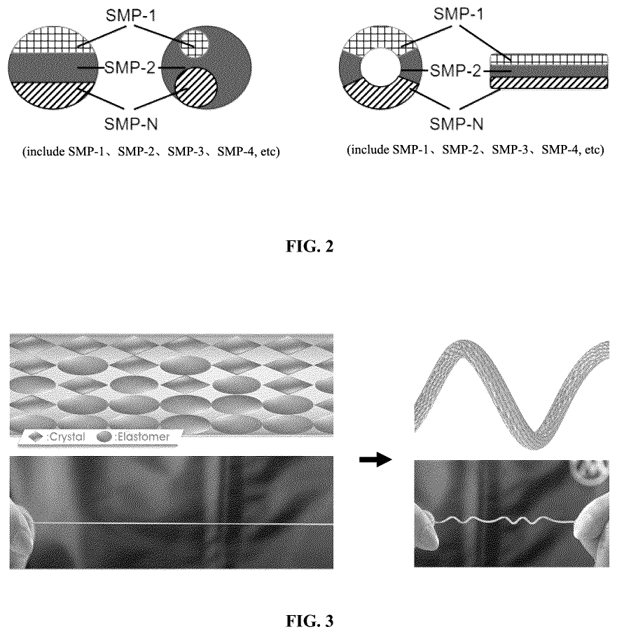

Turning now to the drawings in detail, FIG. 2 schematically depicts the cross section of the elastic copolymer materials, which are composed of at least three shape memory polymers (SMPs). These SMPs are co-extruded through a spinneret, T-die, a side-by-side nozzle, or a slot die coater. From left to right, the structure of side-by-side in thread, eccentric sheath/core in fiber, circumferential in tube and layer-by-layer in tape is listed. The multi-component thread or fiber has a diameter in a range of approximately 0.1 to 2 mm, and the multi-component tube or tape has a thickness in a range of approximately 0.5 to 1 mm. The elastic copolymer materials have the function of stimulus regulating multi-shape change after stretching. The quantity of shape changes after stretching depends on the amount of SMP components in the elastic copolymer materials.

In one embodiment, the SMPs have a glass transition temperature (T_{g}) and/or melting temperature (Tₘ) used as the shape recovery temperature (Tᵣ) of SMPs. The T r of all SMP-N components is between approximately −50 and 100° C.

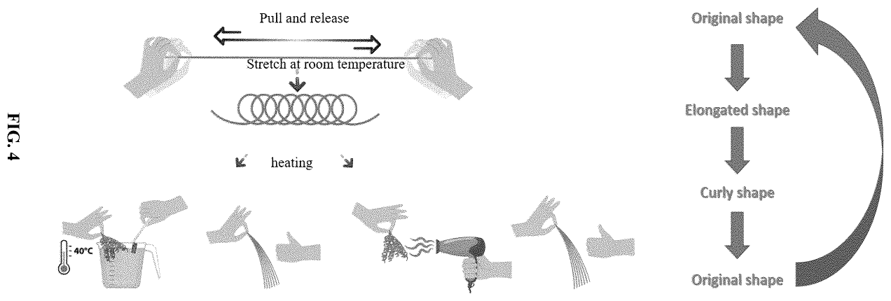

The elastic copolymer materials can be stretched and at least partially fix the elongated shape to form the first shape from the original shape. After stretching under normal conditions, subsequent stimulation on the first shape changes the first shape to the second helical shape. Finally, when the elastic copolymer materials in the second shape are triggered by the stimulus, it will lead to the shape change from the second shape to the third linear shape, which is equivalent to the original shape. This phenomenon arises due to the deformation of the entire structure, encompassing both elastomer and crystal compartments, during the pulling process. However, upon releasing the force, only the elastomer portion rebounds, causing the material to form curls (see FIG. 3). When heat is applied, the deformed crystal compartments melt, relieving the stress, and allowing the material to return to its original shape.

Referring to FIG. 4, in one embodiment, when two thermal-sensitive SMP components SMP-1 and SMP-2 are used in a multi-component filament, it presents the stimulus regulating multi-shape change after stretching. Both SMP-1 and SMP-2 provides pseudo-plasticity at a temperature lower than Tᵣ of the SMPs. For example, Tᵣ₁ is lower than the room temperature and Tᵣ₂ is higher than the room temperature. At room temperature, the longer the time spent repeatedly pulling and releasing the filaments, the denser the resulting helical structure will be in terms of the number of turns. After stretching and releasing at room temperature, the pseudo-plasticity in SMP-2 sides tend to maintain elongation, which causes the formation of a curly shape instantly. If heating above Tᵣ₂, the pseudo-plasticity of SMP-2 will be removed and the original linear shape will be restored. The heating can be achieved by immersing the filaments in water at 40° C. or using a hairdryer with a low hot air setting.

In the case of different stimulus modes, the first stimulus for SMP-1 component may lead to the first shape change and the second stimulus for SMP-2 component may lead to the second shape change. The stimulus may be selected from temperature, moisture/water, light, pH, and radiation. Tᵣ₁ is higher than room temperature and lower than the Tᵣ₂. Stretching the filament to an elongation of 30-300% at a room temperature can give rise to an elongated straight shape, and subsequently heating to Tᵣ₁ can lead to a curled/helical shape. If continuously heating above Tᵣ₂, the shape can be restored from the curled/helical shape back to the original straight shape.

The following examples illustrate the present invention and are not intended to limit the same.

### Example

### Example 1—Preparation Elastic Copolymer Materials

Two SMP-N components can be potentially used in the elastic copolymer materials. Each of SMP-1 and SMP-2 components is of at least 1% of the total weight, and both SMP-1 and SMP-2 are coextruded with a weight ratio of 1:1 by using eccentric nozzles. Thermoplastic polyurethane elastomer is used in SMP-1, and shape memory polyurethane is used in SMP-2. Tᵣ₁ is −30° C., and Tᵣ₂ is 35° C. Prior to processing, all pellets must be dried at 104° C. for 2-4 hours. The barrel temperature of extruder would be 180-195° C. (zone 1), 185-200° C. (zone 2), 190-205° C. (zone 3), 190-200° C. (Die zone). Screw speed is 180-200 rpm. Next, the extruded filament is cooled in cold water with a temperature of 15° C. from the nozzles without any stretching process.

Stretching the elastic copolymer materials to an elongation of 30-300% at a room temperature can give rise to an curled/helical shape, and subsequently heating to 40° C. can lead to a straight shape.

### Example 2—Using the Game Kit of the Present Invention

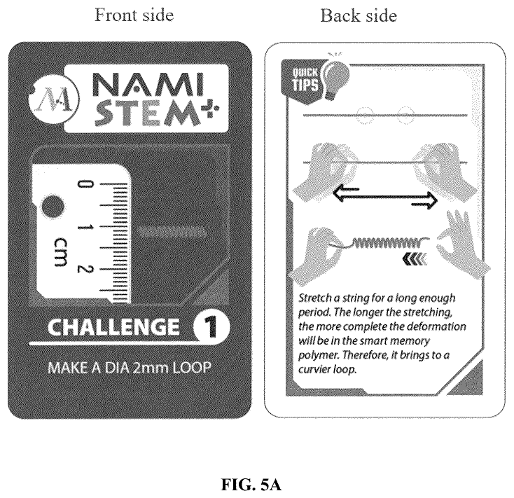

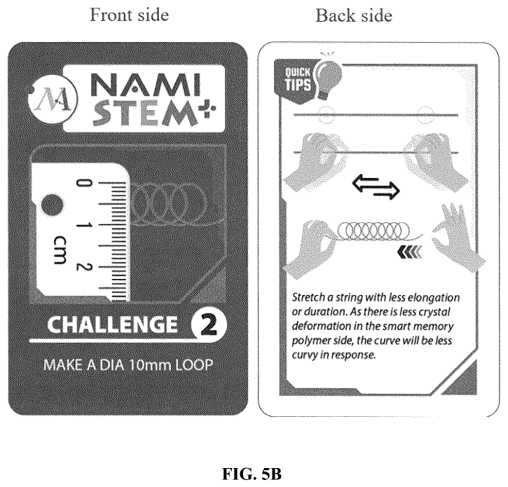

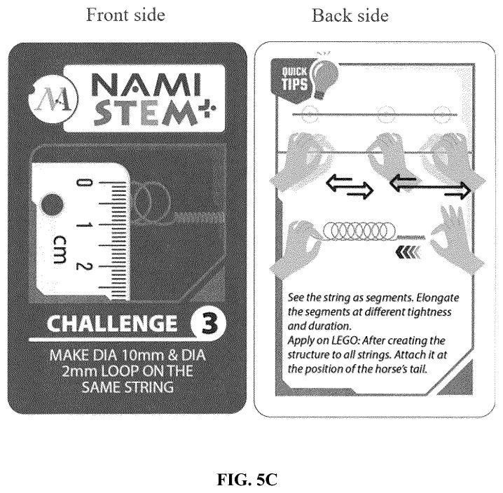

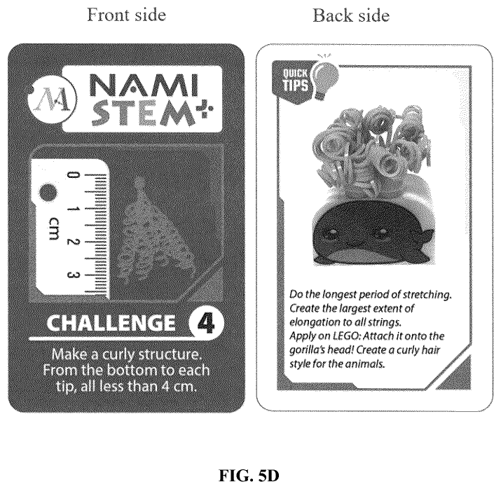

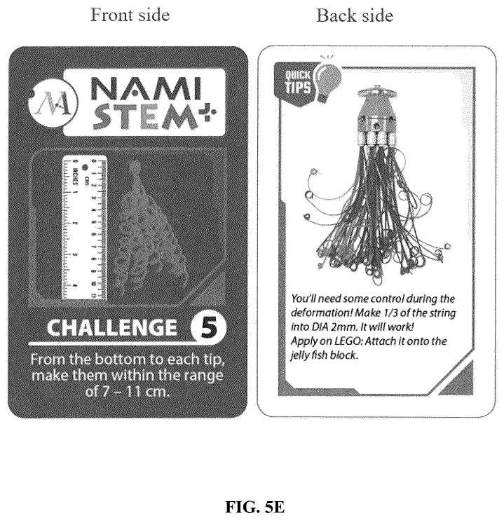

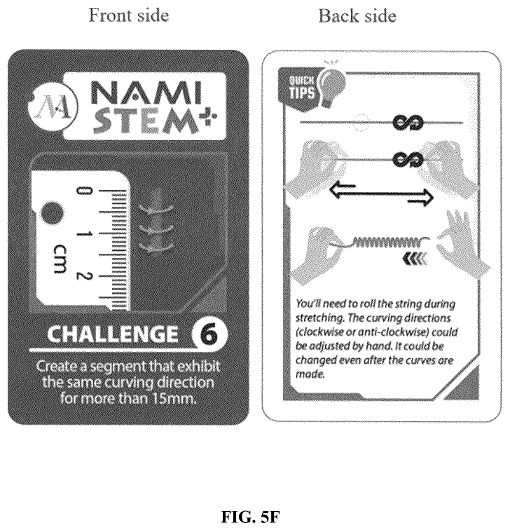

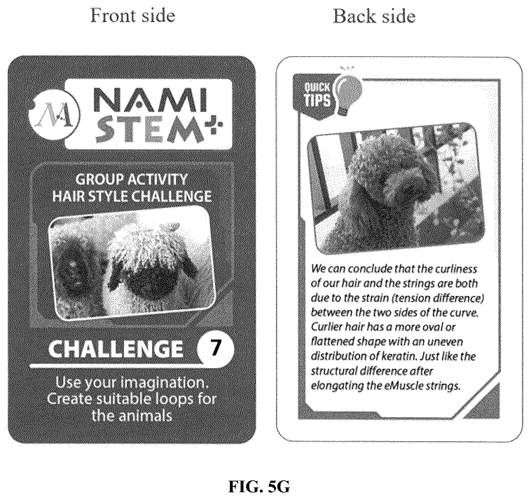

In the kit, there are at least 8 mission cards, each listing the specified structures of elastic copolymer filaments that the user needs to create (FIGS. 5A-5G). In this example, the process of generating shapes specified by various mission cards in the provided invention kit was outlined.

In challenge no. 1, the objective is to generate a helical structure with a diameter of 2 mm By elongating the filament for an extended duration, the degree of deformation in the filament becomes more pronounced. Consequently, the longer stretching results in a more complete deformation, thereby forming a loop with a smaller diameter.

In challenge no. 2, the objective is to generate a helical structure with a diameter of 10 mm. As mentioned earlier, users can reduce crystal deformation by shortening the extended duration, which in turn leads to a helical structure with a larger diameter.

In challenge no. 3, the objective is to generate a helical structure on the same filament with diameters of both 2 mm and 10 mm simultaneously. The method involves elongating the filament at different tightness and durations. A shorter extended duration results in a larger diameter, while conversely, a longer extended duration leads to a smaller diameter.

In challenge no. 4, the objective is to generate a plurality of helical structures with a length of less than 4 cm. Following the instructions from challenge no. 1, repeatedly transform multiple filaments into curled shapes and use a connector to gather all filaments together.

In challenge no. 5, the objective is to generate a plurality of helical structures with a length of 7-11 cm. This is achieved by using only one-third of the filaments for pulling and stretching, forming helical structures with a diameter of 2 millimeters at the ends of the filaments.

In challenge no. 6, the objective is to create a segment that exhibits the same curving direction for more than 15 mm Users need to roll the filament during stretching. The curving directions can be clockwise or counterclockwise, and can be adjusted by hand.

In challenge no. 7, there are no restrictions on the quantity and shape of the filaments, allowing users to engage in creative and unrestricted designs.

### Example 3—Applications of the Shape Memory Polymer-Based Game Kit

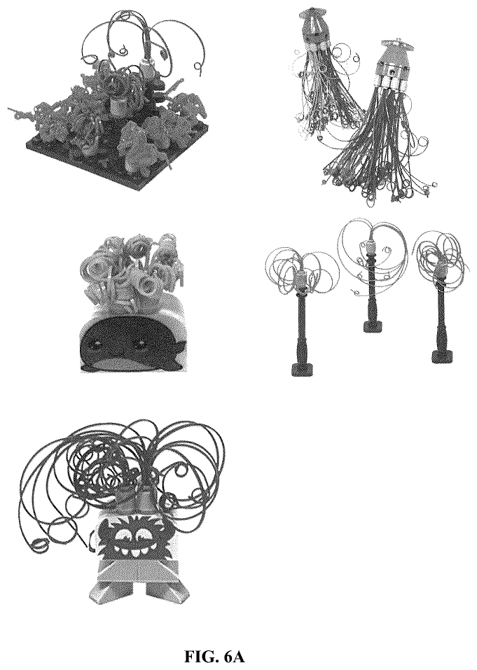

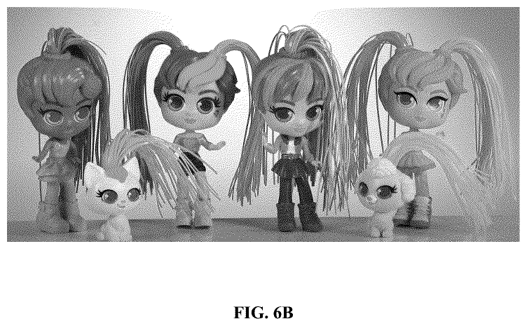

Turning to FIG. 6A, the kit of the present invention extends its versatility by potentially incorporating one or more building blocks (e.g., LEGO® bricks). The elastic copolymer materials provided in the kit can be skillfully assembled onto the LEGO® bricks, giving rise to visually novel and innovative designs. For instance, these elastic copolymer materials find application within LEGO® creations, serving as integral components for various designs, such as mimicking the hair/tail of an animal, the hands and feet of a figurine, the flowing water, tentacles of a jellyfish, a decorative bouquet, leaves, and more. The flexibility of the elastic copolymer materials allows users to unleash their creativity and bring a unique touch to their LEGO® constructions.

It can also be applied to other toys, including dolls' hair (see FIG. 6B), jump ropes, spring toys, and automotive components, etc.

In addition to toys, the kit can be further applied to other designs, such as decorations, artworks, clothing, household items, or product surface designs, or other creative projects.

Examples of the decorations include wreaths, hanging ornaments, table centerpieces, customized party decorations, etc.

Examples of the artworks include mixed-media art pieces, innovative 3D canvas art showcasing dynamic textures, wall-mounted artworks, contemporary art installations, etc.

Examples of the clothing include fashion accessories like bracelets and necklaces, decorative patches or accents, belts, shoelaces, etc.

Examples of the household items include coasters, curtain ties, an insulation outer covering of electrical wires, telephone cords, a strap or lanyard for a mobile phone, straps of a backpack, etc.

### Definitions

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The term “linear” or “straight” used herein to describe a state of the present multi-component shape memory threads, fibers, tubes, or tapes refer to a closely or substantially linear state of an as-formed multi-component shape memory threads, fibers, tubes, or tapes of the present invention which can be observed visually or determined qualitatively and/or quantitatively.

The terms “fiber” used herein, refer to a three-dimensional structure with an elongated morphology. In some contexts, the term “fiber” can also refer to a slender threadlike object or article.

The term “shape memory polymer” or “shape-memory polymeric component” used herein, or sometimes they are used interchangeably, refers to a unique class of polymers or materials which exhibit the ability to fix a temporary shape and then resume to a prior state by an external stimulus (e.g. heat, radiation, solvent, electrical current, light, magnetic fields, or a change in pH).

The term “elastomer” or “elastomeric component” used herein, or sometimes they are used interchangeably, refers to a material which exhibits the property of elasticity, low Young's modulus (i.e. the ratio of tensile stress to tensile strain) and with the ability to deform when a stress is applied and resume to its original form (i.e., length, volume, shape, etc.) when the stress is removed. Examples of elastomers used in the present invention include, but are not limited to polyester or polyether-based polyurethanes.

Other definitions for selected terms used herein may be found within the detailed description of the present invention and apply throughout. Unless otherwise defined, all other technical terms used herein have the same meaning as commonly understood to one of ordinary skill in the art to which the present invention belongs.

It will be appreciated by those skilled in the art, in view of these teachings, that alternative embodiments may be implemented without undue experimentation or deviation from the spirit or scope of the invention, as set forth in the appended claims. This invention is to be limited only by the following claims, which include all such embodiments and modifications when viewed in conjunction with the above specification and accompanying drawings.

What is claimed is:

1. A shape memory polymer-based game kit, comprising:
a plurality of elastic copolymer materials, wherein each of the elastic copolymer materials being mechanically manipulate able from its original shape into one or more three-dimensional structures, and reverse back to its original shape by being subjected to a stimulus;
an instruction manual comprising one or more user instructions specifying rules of one or more games;
wherein the one or more three dimensional structures include one or more of curls, spirals, ringlets, waves, and coils; and
wherein the stimulus is a thermal energy having a temperature at or above the shape recovery temperature, the thermal energy is carried and radiated by a medium selected from one or more of air, water, and other fluid.

2. The shape memory polymer-based game kit of claim 1, wherein the plurality of elastic copolymer materials comprise multi-component shape memory threads, fibers, tubes, or tapes.

3. The shape memory polymer-based game kit of claim 1, wherein the plurality of elastic copolymer materials are made of at least two shape-memory polymeric (SMP-N) components, each of the at least two SMP-N components is of at least 1% of the total weight, and N is a positive integer starting from 1.

4. The shape memory polymer-based game kit of claim 3, wherein the SMP-N components have a selectively engineered shape recovery temperature (Tᵣ) between approximately −50 and 100° C., and the recovery temperature of two or more different components can be represented by T_{rN} and T_{rN+1} respectively.

5. The shape memory polymer-based game kit of claim 4, when T_{rN} and T_{rN+1} are higher than room temperature and wherein T_{rN+1} is greater than Tr_{N}, the plurality of elastic copolymer materials is configured to assume a first shape change from an original shape to a straight, elongated shape in response to an elongation of the plurality of elastic copolymer materials to approximately 30% to approximately 300% of an original length and are configured to assume a second shape change to a substantially helical shape upon heating to a temperature above the T_{rN} and lower than the T_{rN+1} and to assume a third shape change substantially back to the original shape upon heating to a temperature above T_{rN+1}.

6. The shape memory polymer-based game kit of claim 4, when T_{rN} is lower than room temperature and T_{rN+1} are higher than room temperature and wherein T_{rN+1} is greater than Tr_{N}, the plurality of elastic copolymer materials is configured to assume the shape change from a first straight shape to a second helical shape in response to an elongation of the plurality of elastic copolymer materials to approximately 30% to approximately 300% of an original length. The shape change from helical shape back to the original straight shape upon heating to a temperature above the T_{rN+1}.

7. The shape memory polymer-based game kit of claim 1, wherein the one or more three dimensional structures of the plurality of elastic copolymer materials change by adjusting an elongation length or a stretching time of the plurality of elastic copolymer materials.

8. The shape memory polymer-based game kit of claim 1, wherein the one or more of curls, spirals, ringlets, waves, or coils have a coil diameter from 0.5 to 10 mm and a number of the turns per cm from 5 to 30.

9. The shape memory polymer-based game kit of claim 7, wherein the elongation length is in a range of 0.5-50 cm.

10. The shape memory polymer-based game kit of claim 7, wherein the stretching time is in a range of 0.1-60 s.

11. The shape memory polymer-based game kit of claim 1, further comprising one or more challenge cards, wherein each of the challenge cards comprises at least a task prompting a user to manipulate the plurality of elastic copolymer materials into a specified structure.

12. The shape memory polymer-based game kit of claim 1, wherein the shape memory polymer-based game kit further comprises a container to hold the thermal fluid.

13. The shape memory polymer-based game kit of claim 12, wherein the shape memory polymer-based game kit further comprises a thermometer for measuring the thermo fluid temperature that helps protecting the user and allow the user to adjust the temperature of the thermo fluid.

14. The shape memory polymer-based game kit of claim 1, further comprising one or more building blocks with various shapes, wherein each of the building blocks is configured to be attachable to another one of the building blocks via a connector;
wherein each of one or more of the elastic copolymer materials is coupled to a connector for attaching to one of the building blocks.

15. The shape memory polymer-based game kit of claim 1, further comprising one or more building plates, wherein each of one or more of the elastic copolymer materials is coupled to a connector for attaching to one of the building plates.

16. The shape memory polymer-based game kit of claim 1, wherein the one or more user instructions are printed on cards, papers, or a link provided to an interactive online, or downloadable video guide for games, or a combination thereof.

17. A shape memory polymer-based artwork tool kit, comprising:
a plurality of elastic copolymer filaments;
wherein each of the elastic copolymer filaments being mechanically manipulatable from its original shape into one or more three-dimensional structures, and reverse back to its original shape by being subjected to a stimulus having a shape recovery temperature;
wherein at least one of the elastic copolymer filaments having a color different from another one of elastic copolymer filaments; and one or more artwork tools.

18. The shape memory polymer-based artwork tool kit of claim 17, wherein the artwork tools comprise one or more brushes, rollers, molds, presses, extruders, blades, cutters, printers, or tubes.
